(19) United States
(12) Patent Application Publication
(10) Pub. No.: US 2024/0311636 A1
(43) Pub. Date: Sep. 19, 2024

(54) MACHINE LEARNING MODEL TRAINING USING FEATURE SPACE ANALYSIS

(71) Applicant: The Aerospace Corporation, El Segundo, CA (US)

(72) Inventors: Benjamen Paul Bycroft, Los Angeles, CA (US); Avinash Mayank Vakil, San Jose, CA (US); Ryan Scott Williams, Redondo Beach, CA (US)

(21) Appl. No.: 18/184,428

(22) Filed: Mar. 15, 2023

(51) Int. Cl. G06N 3/082; G06N 3/04

(52) U.S. Cl. CPC G06N 3/082; G06N 3/04

(57) ABSTRACT

Systems and methods are provided for using results of feature space analysis during the training of machine learning models to improve the training process and the resulting trained model.

### BACKGROUND

Models representing data relationships and patterns, such as functions, algorithms, systems, and the like, may accept input (sometimes referred to as an input vector), and produce output (sometimes referred to as an output vector) that corresponds to the input in some way. For example, a machine learning model may be implemented as an artificial neural network. Artificial neural networks are artificial in the sense that they are computational entities, analogous to biological neural networks, but implemented by computing devices. Output of neural network-based models is typically in the form of a score. The parameters of a neural network-based models can be set in a process referred to as training.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a diagram of training an illustrative artificial neural network and generating a confidence model for training-support-based augmentation according to some embodiments.

FIG. 2 is a flow diagram of an illustrative routine for training a machine learning model and adjusting the model or training process based on analysis of the feature space during training according to some embodiments.

FIG. 3 is a diagram of illustrative distributions in a feature space and adapting training of a model based on evaluation of the feature space according to some embodiments.

FIG. 4 is a diagram of illustrative distributions in a feature space and adapting training or structure of a model based on evaluation of the feature space according to some embodiments.

FIG. 5 is a diagram of an illustrative artificial neural network with its structure being modified based on evaluation of a feature space during training according to some embodiments.

FIG. 6 is a block diagram of an illustrative computing system configured to implement aspects of the present disclosure according to some embodiments.

### DETAILED DESCRIPTION

The present disclosure is directed to using results of feature space analysis during the training of machine learning models to improve the training process and the resulting trained model. Generally described, a machine learning model may be trained to generate prediction output (e.g., classification output or regression output). During training, the machine learning model may generate training outputs from training inputs, and parameters of the machine learning model may be modified based on the training outputs. For example, the machine learning model may determine or generate feature space data that represents the training input within a feature space that is being learned as part of the training process. The feature space data may represent a particular point in a multidimensional feature space. Such a point is referred to herein as a feature space point. The feature space points that have been generated over the course of evaluating multiple training inputs and generating corresponding training outputs can be analyzed to determine the performance of the training process at the feature space level. Performance of the training process at the feature space level may be defined in terms of the separability of points within the feature space, accuracy of training output associated with particular areas of the feature space, and the like.

Some conventional machine learning models are configured and trained to produce output such as classification scores that reflect the likelihood or “confidence” that a particular input is properly classified or not classified in a particular class. For example, input may be analyzed using a machine learning model, and the output of the analysis for a particular classification may be a classification score in the range [0.0, 1.0]. A higher score indicates a higher probability or confidence that the input is properly classified in the particular classification, and a lower score indicates a lower probability or confidence that the input is properly classified in the particular classification. During training, a feature space is learned into which the model maps input and from which the model generates prediction output. However, the regions of the feature space associated with different outputs (e.g., classes) may not be well separated. For example, feature space points associated with one class may be near—in a mathematically-defined spatial sense—feature space points associated with one or more other classes. In some cases, feature space points of different classes may overlap or otherwise intermingle within the feature space. Although a model can be trained to accurately generate prediction output in such cases, the model may not generalize well when presented with never-before-seen input, or the model may suffer from sub-optimal performance in other ways. Another potential issue is that the trained model may generate output that is associated with a high number of false positives and/or false negatives for such data. When relevant training data is lacking or the results produced by the trained model on relevant training data are not adequately reliable, the trained model nevertheless still produces classification output. The output may be indicative of a relatively high confidence in a classification determination (e.g., the confidence score may be close to 1.0) and may be provided without any indication that the training basis is inadequate, or that the model is unreliable in that region of the feature space. Thus, a consumer of such model output may not have any way of discriminating between high confidence scores in cases where there is a substantial training basis and an effective model, and high confidence scores in cases where there is a lack of adequate training basis or an ineffective model. Similar issues arise with conventional machine learning models configured and trained to produce regression output. Although the regression models may be associated with confidence metrics that are determined over the entire domain of inputs, a consumer of output from such a model may not have any way of determining the confidence with which any particular output was generated from any particular input.

Some aspects of the present disclosure address some or all of the issues noted above, among others, through adjustment of model training processes—or adjustment of a model itself—based on analysis of feature space data observed at training time. The feature space data (e.g., feature space points) may be generated from training data input when generating training data output at training time. By analyzing the feature space data, potential issues such as areas of inadequate separability between regions of the feature space associated with different classes or other output, areas of the feature space associated with poor performance, and the like can be identified and addressed. In some embodiments, each individual feature space point observed at training time, or a statistically significant portion thereof, can be saved for evaluation. In some embodiments, data regarding the feature space points may be maintained, such as a model or function (e.g., a curve) describing the observed feature space points. Evaluation of the feature space data observed at training time (whether individual feature space points, or representations of the feature space points) can result in identification of various potential issues to be addressed.

In some embodiments, poor separability of feature space points associated with two or more classes or groups of regression output can be identified. To identify poor separability, one or more distance metrics may be generated in order to determine a spatial distance between clusters of feature space points or regions of the feature space associated with different outputs. For example, a Bhattacharyya distance, a Mahalanobis distance, or a Wasserstein metric may be generated to represent the distance between [1] a centroid or other representative point associated with a first class, and [2] a centroid or other representative point associated with a second class as determined during training. If the distance metric fails to satisfy a threshold, then a detection of poor separability may be triggered.

In some embodiments, poor performance such as feature space regions associated with a relatively large number of false positives or false negatives can be identified. To identify such poor performance, the training output generated by the model from the feature space points may be evaluated against the labeled or desired output, and inaccuracies can be identified. A clustering algorithm, such as k-means clustering, density-based spatial clustering of applications with noise (DBSCAN), or the like may be performed on feature space points associated with false positives or false negatives, and any resulting clusters may be identified as feature space regions of poor performance.

Additional aspects of the present disclosure relate to addressing, at training time, feature space-based issues such as poor separability, poor performance, or the like. Advantageously, addressing the feature space-based issues during the training process (e.g., before a trained model is deployed) can result in a trained model that is more efficient, more accurate, produced more efficiently, or some combination thereof.

In some embodiments, the structure of a model may be adjusted during training in response to detection of a feature space-based issue. For example, if poor separability or poor accuracy has been detected and the model being trained is an artificial neural network, then additional nodes and/or layers may be added to the model.

In some embodiments, parameters of a model, data used to train the model, or aspects of the training process itself may be adjusted during training in response to detection of a feature space-based issue. For example, if poor accuracy has been detected, then a loss function used to evaluate training output and adjust model parameters may be modified so that training is emphasized in the feature space region associated with poor accuracy. As another example, if poor separability is detected, model parameters may be re-initialized, or the loss function used to evaluate training output and adjust model parameters may be modified so that training is emphasized in the feature space region associated with poor separability.

Various aspects of the disclosure will now be described with regard to certain examples and embodiments, which are intended to illustrate but not limit the disclosure. Although the examples and embodiments described herein will focus, for the purpose of illustration, on specific calculations and algorithms, one of skill in the art will appreciate the examples are illustrative only, and are not intended to be limiting. In addition, any feature, process, device, or component of any embodiment described and/or illustrated in this specification can be used by itself, or with or instead of any other feature, process, device, or component of any other embodiment described and/or illustrated in this specification

### Example Training of a Prediction Model

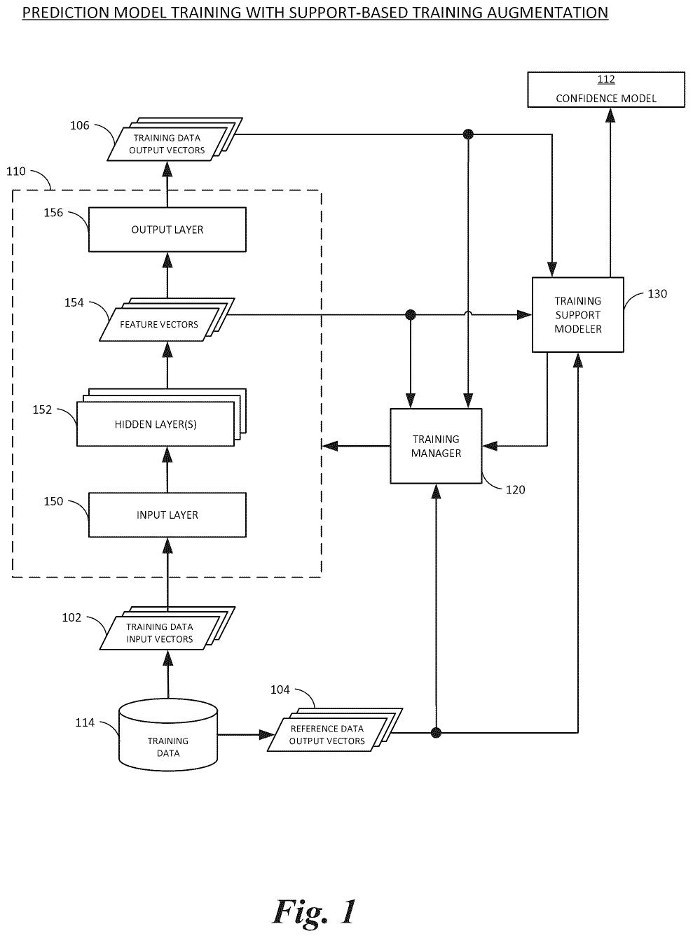

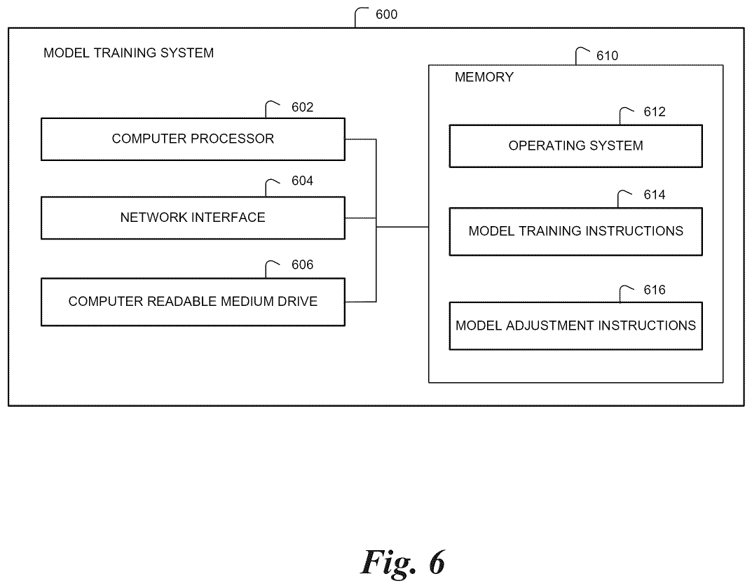

FIG. 1 illustrates training of a prediction model 110 and optional generation of a confidence model 112 by a model training system (such as the model training system 600 shown in FIG. 6 and described in greater detail below) according to some embodiments. In the illustrated example, the prediction model 110 is implemented as an artificial neural network (“NN”). However, feature space analysis may be applied to training of any machine learning model, including but not limited to: neural-network-based classification models, neural-network-based regression models, linear regression models, logistic regression models, decision trees, random forests, support vector machines (“SVMs”), Naïve or non-Naïve Bayes networks, k-nearest neighbors (“KNN”) models, k-means models, clustering models, or any combination thereof. For brevity, aspects of feature space analysis-based training may not be described with respect to each possible machine learning model that may be used. In practice, however, many or all of the aspects of the disclosure may apply to other machine learning models, including but not limited to those listed herein. In addition, although certain embodiments are described with respect to using certain methods of estimating distributions and mixture densities of training data and/or features derived therefrom, other methods may be used.

Generally described, NNs—including deep neural networks (“DNNs”), convolutional neural networks (“CNNs”), recurrent neural networks (“RNNs”), other NNs, and combinations thereof—have multiple layers of nodes, also referred to as “neurons.” Illustratively, a NN may include an input layer, an output layer, and any number of intermediate, internal, or “hidden” layers between the input and output layers. The individual layers may include any number of separate nodes. Nodes of adjacent layers may be logically connected to each other, and each logical connection between the various nodes of adjacent layers may be associated with a respective weight. Conceptually, a node may be thought of as a computational unit that computes an output value as a function of a plurality of different input values. Nodes may be considered to be “connected” when the input values to the function associated with a current node include the output of functions associated with nodes in a previous layer, multiplied by weights associated with the individual “connections” between the current node and the nodes in the previous layer. When a NN is used to process input data in the form of an input vector or a matrix of input vectors (e.g., a batch of training data input vectors), the NN may perform a “forward pass” to generate an output vector or a matrix of output vectors, respectively. The input vectors may each include n separate data elements or “dimensions,” corresponding to the n nodes of the NN input layer (where n is some positive integer). Each data element may be a value, such as a floating-point number or integer. A forward pass typically includes multiplying the matrix of input vectors by a matrix representing the weights associated with connections between the nodes of the input layer and nodes of the next layer, and applying an activation function to the results. The process is then repeated for each subsequent NN layer. Some NNs have hundreds of thousands or millions of nodes, and millions of weights for connections between the nodes of all of the adjacent layers.

As shown in FIG. 1, the example prediction model 110 implemented as a NN has an input layer 150 with a plurality of nodes, one or more internal layers 152 (also referred to as “hidden layers”) with a plurality of nodes, and an output layer 156 with a plurality of nodes. The specific number of layers shown in FIG. 1 is illustrative only, and is not intended to be limiting. In some NNs, different numbers of internal layers and/or different numbers of nodes in the input, internal, and/or output layers may be used. For example, in some NNs the layers may have hundreds or thousands of nodes or more. As another example, in some NNs there may be 1, 2, 4, 5, 10, 50, or more internal layers. In some implementations, each layer may have the same number or different numbers of nodes. For example, the input layer 150 or the output layer 156 can each include more or less nodes than the internal layers 152. The input layer 150 and the output layer 156 can include the same number or different number of nodes as each other. The internal layers 152 can include the same number or different numbers of nodes as each other.

Input to a NN, such as the prediction model 110 shown in FIG. 1, occurs at the input layer 150. A single input may take the form of an n-dimensional input vector with n data elements, where n is the number of nodes in the input layer 150. During training, the input vector may be a training data input vector 102. In some cases, multiple input vectors may be input into—and processed by—the NN at the same time. For example, when the NN is trained, a set of training data input vectors 102 (e.g., a “mini batch”) may be arranged as an input matrix. In this example, each row of the input matrix may correspond to an individual training data input vector 102, and each column of the input matrix may correspond to an individual node of the input layer 150. The data element in any given training data input vector 102 for any given node of the input layer 150 may be located at the corresponding intersection location in the input matrix.

The connections between individual nodes of adjacent layers are each associated with a trainable parameter, such as a weight and/or bias term, that is applied to the value passed from the prior layer node to the activation function of the subsequent layer node. For example, the weights associated with the connections from the input layer 150 to the internal layer 152 it is connected to may be arranged in a weight matrix W with a size m×n, where m denotes the number of nodes in an internal layer 152 and n denotes the dimensionality of the input layer 150. The individual rows in the weight matrix W may correspond to the individual nodes in the input layer 150, and the individual columns in the weight matrix W may correspond to the individual nodes in the internal layer 152. The weight w associated with a connection from any node in the input layer 150 to any node in the internal layer 152 may be located at the corresponding intersection location in the weight matrix W.

Illustratively, the training data input vector 102 may be provided to a computer processor that stores or otherwise has access to the weight matrix W. The processor then multiplies the training data input vector 102 by the weight matrix W to produce an intermediary vector. The processor may adjust individual values in the intermediary vector using an offset or bias that is associated with the internal layer 152 (e.g., by adding or subtracting a value separate from the weight that is applied). In addition, the processor may apply an activation function to the individual values in the intermediary vector (e.g., by using the individual values as input to a sigmoid function or a rectified linear unit (“ReLU”) function).

In some embodiments, there may be multiple internal layers 152, and each internal layer may or may not have the same number of nodes as each other internal layer 152. The weights associated with the connections from one internal layer 152 (also referred to as the “preceding internal layer”) to the next internal layer 152 (also referred to as the “subsequent internal layer”) may be arranged in a weight matrix similar to the weight matrix W, with a number of rows equal to the number of nodes in the subsequent internal layer 152 and a number of columns equal to the number of nodes in the preceding internal layer 152. The weight matrix may be used to produce another intermediary vector using the process described above with respect to the input layer 150 and first internal layer 152. The process of multiplying intermediary vectors by weight matrices and applying activation functions to the individual values in the resulting intermediary vectors may be performed for each internal layer 152 subsequent to the initial internal layer.

The intermediary vector that is generated from the last internal layer 152 prior to the output layer 156 may be referred to as a feature vector 154. The feature vector 154 includes data representing the features that have been extracted from the training data input vector 102 by the NN. Illustratively, the feature vector 154 may be thought of as defining a point in the feature space within which the NN is configured to operate. The feature space is determined over the course of design and training of the model, and is expected to encompass the relevant features used to make accurate output determinations (e.g., classification determinations or regression determinations). Thus, the feature vector 154 generated from any given input vector 102 may be considered to be a processed, distilled representation of the relevant information regarding the input vector 102 from which an output determination is to be made.

In some embodiments, an intermediary vector generated from an internal layer other than the last internal layer may be the feature vector 154. For example, the feature vector 154 may include output of the second-to-last internal layer, third-to-last internal layer, first internal layer, or a combination of data from multiple internal layers that may or may not include the last internal layer. Illustratively, such configurations may be beneficial for NN architectures such as autoencoder/decoder networks, U-Nets, RNNs, and the like where feature spaces that would be most useful may found in layers or combinations of layers other than the last internal layer. In some embodiments, there may be no output layer 156, and therefore the feature vector 154 may be final output of the NN.

The output layer 156 of the NN makes output determinations from the feature vector 154. Weights associated with the connections from the last internal layer 152 to the output layer 156 may be arranged in a weight matrix similar to the weight matrix W, with a number of rows equal to the number of nodes in the output layer 156 and a number of columns equal to the number of nodes in the last internal layer 152. The weight matrix may be used to produce an output vector 106 using the process described above with respect to the input layer 150 and first internal layer 152.

The output vector 106 may include data representing the classification or regression determinations made by the NN for the training data input vector 102. Some NNs are configured make u classification determinations corresponding to u different classes (where u is a number corresponding to the number of nodes in the output layer 156, and may be less than, equal to, or greater than the number of nodes n in the input layer 150). The data in each of the u different dimensions of the output vector 106 may be a confidence score indicating the probability that the training data input vector 102 is properly classified in a corresponding class. Some NNs are configured to generate values based on regression determinations. The output value(s) is/are based on a mapping function modeled by the NN. Thus, an output value from a NN-based regression model is the value that corresponds to the training data input vector 102.

The training data 114 from which the training data input vectors 102 are drawn may also include reference data output vectors 104. Each reference data output vector 104 may correspond to a training data input vector 102, and may include the “correct” or otherwise desired output that a model should produce for the corresponding training data input vector 102. For example, a reference data output vector 104 may include scores indicating the proper classification(s) for the corresponding training data input vector 102 (e.g., scores of 1.0 for the proper classification(s), and scores of 0.0 for improper classification(s)). As another example, a reference data output vector 104 may include scores indicating the proper regression output(s) for the corresponding training data input vector 102.

The goal of training may be to minimize the difference between the training data output vectors 106 and corresponding reference data output vectors 104. Evaluation of training data output vectors 106 with respect to the reference data output vectors 104 may be performed using a loss function (also referred to as an objective function), such as a binary cross entropy loss function, a weighted cross entropy loss function, a squared error loss function, a softmax loss function, some other loss function, or a composite of loss functions. A gradient of the loss function with respect to the parameters (e.g., weights) of the prediction model 110 may be computed. The gradient can be used to determine the direction in which individual parameters of the model 110 are to be adjusted in order to minimize the loss function and, therefore, minimize the degree to which future output (e.g., training data output vectors 106) differs from expected or desired output (reference data output vectors 104). The degree to which individual parameters are adjusted may be predetermined or dynamically determined (e.g., based on the gradient and/or a hyperparameter). For example, a hyperparameter such as a learning rate may specify or be used to determine the magnitude of the adjustment to be applied to individual parameters of the model 110.

In some embodiments, the model training system can compute the gradient for a subset of the training data, rather than the entire set of training data. Therefore, the gradient may be referred to as a “partial gradient” because it is not based on the entire corpus of training data 114. Instead, it is based on the differences between the training data output vectors 106 and the reference data output vectors 104 when processing only a particular subset of the training data 114.

In some embodiments, the model training system can update some or all parameters of the model 110 using a gradient descent method with back propagation. In back propagation, a training error is determined using a loss function (e.g., as described above). The training error may be used to update the individual parameters of the model 110 in order to reduce the training error. For example, a gradient may be computed for the loss function to determine how the weights in the weight matrices are to be adjusted to reduce the error. The adjustments may be propagated back through the model 110 layer-by-layer.

The model training system, or a subsystem thereof such as a training manager 120, can manage the training process by evaluating one or more stopping criteria. For example, a stopping criterion can be based on the accuracy of the model 110 as determined using the loss function, a test set, or both. If the accuracy satisfies a threshold or other criterion, the model 110 may be considered to have “converged” on a desired or adequate result and the training process may be stopped. As another example, a stopping criterion can be based on the number of iterations (e.g., “epochs”) of training that have been performed, the elapsed training time, or the like.

Instead of—or in addition to—the stopping criteria described above, the training manager 120 may use feature space analysis to determine whether to stop the training. In some embodiments, the training manager 120 may use feature space analysis to determine whether and how to modify training or the model 110 itself. Feature space analysis may be based on feature space data, such as feature vectors 154, generated during the training process (e.g., during forward passes).

In some embodiments, analysis of the feature space may include evaluating the degree to which feature space point clusters are separated within the feature space. For example, if the model 110 is being trained as a classifier, then feature vectors 154 generated from training data input vectors 102 that are properly classified into different classes may be clustered into corresponding different regions of the feature space. It may be desirable maximize the degree of separation between clusters of feature space points associated with different classes.

In some embodiments, analysis of the feature space may include evaluating which regions of the feature space tend to perform more poorly than other regions or a benchmark. For example, if the model 110 is being trained as a classifier, then feature vectors 154 generated from training data input vectors 102 that are improperly classified into different classes may be clustered into particular regions of the feature space. It may be desirable identify such feature space regions so that mitigations can be implemented, such as performing additional training, modifying loss function output during training, modifying the structure of the model 110, or the like.

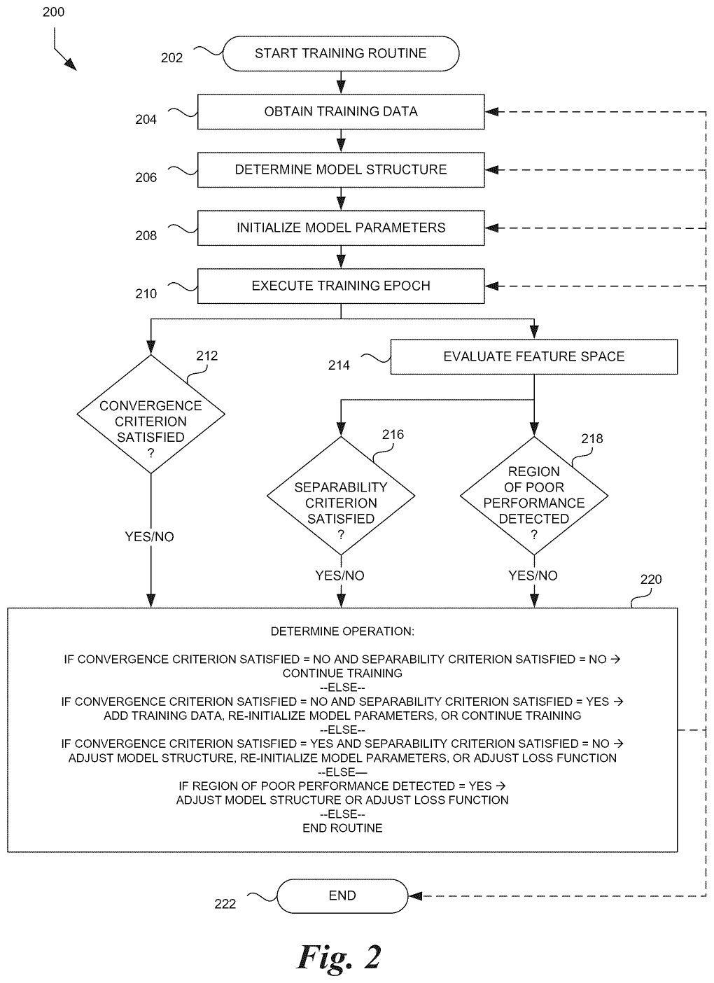

An example routine for using feature space analysis to determine whether to stop training, how to modify training, how to modify the model 110, or some combination thereof is shown in FIG. 2 and described in greater detail below.

The feature vectors 154, in addition to being used to generate output vectors 106 and manage the training process as described above, may also be analyzed to determine various training-support-based metrics. A confidence model 112 may be generated to represent the training-support-based metrics.

To generate a confidence model 112 or otherwise determine training-supported-based metrics once the prediction model 110 has been partially or completely trained, the training data input vectors 102 may be analyzed again using the prediction model 110 to generate feature vectors 154 and output vectors 106. A training support modeler 130 may then analyze the output vectors 106 with respect to the corresponding reference data output vectors 104 to determine whether prediction model 110 has produced output in various training-support-based classes. In some embodiments, if the prediction model 110 is a classification model, the training-support-based classes may include: a true positive classification (“TP”), a false positive classification (“FP”), a true negative classification (“TN”), and/or a false negative classification (“FN”) for a given training data input vector 102. The feature vectors 154 generated from each training data input vector 102 may then be tagged or otherwise associated with the TP. FP. TN, and FN determinations. The training support modeler 130 may determine one or more training support mixture density functions, distributions, or related metrics for use in augmenting the classification determinations made by the trained model 110 and/or for use by the model 110 itself to generate the classification determinations. In some embodiments, if the prediction model 110 is a regression model, the training-support-based classes may include: a small error, a large positive error, and/or a large negative error for a given training data input vector 102. The feature vectors 154 generated from each training data input vector 102 may then be tagged or otherwise associated with the small error, large positive error, and large negative error determinations. The training support modeler 130 may determine one or more training support mixture density functions, distributions, or related metrics for use in augmenting the regression determinations made by the trained machine learning model and/or for use by the machine learning model itself to generate the regression determinations.

In some embodiments, the training support modeler 130 may determine mixture density functions, distributions, or related metrics of other types. For example, the distributions may also or alternatively include a distribution of all training points regardless of status of TP, FP, TN, FN, large error, small error, etc. (e.g., to identify regions where there is insufficient support for regression determinations). As another example, the distributions may be distributions of any other data available at training time, such as metadata regarding individual training items (e.g., image metadata such as exposure, zoom, lens, date/time, etc.). As a further example, the distributions may be distributions of data derived after training. Illustratively, a NN may be used to detect and identify corners (“keypoints”) of an object in an image. Those keypoints may be used by an unrelated algorithm after the NN to estimate the position and orientation (“pose”) of the object. A distribution for the keypoint detection NN could be generated using the outputs of the pose estimation—such as “error in the true and estimated angle about X, Y, Z”—even if those results were not available at training time for the NN.

Illustrative processes for generating training support mixture density functions, distributions, or related metrics for models, including classification models and regression models, are described in greater detail in commonly-owned U.S. patent application Ser. No. 17/249,604, filed Mar. 5, 1021 and titled Training-Support-Based Machine Learning Classification and Regression Augmentation, the contents of which are incorporated by reference herein and made part of this specification.

### Example Routine for Managing Training Using Feature Space Analysis

FIG. 2 illustrates an example routine 200 for using feature space analysis to manage the training of a machine learning model. Advantageously, a model training system 600 may execute the routine 200 or portions thereof to detect and address potential issues in training, such as poor separability in the feature space or regions of poor performance in the feature space. Based on detection of such conditions, various mitigations or improvements may be implemented, such as re-initialization of model parameters, adjustment of model structure, or adjustment of the loss function used during training.

Routine 200 begins at block 202. In some embodiments, routine 200 may begin in response to an event, such as the model training system 600 beginning operation or being instructed to train a prediction model 110. When the routine 200 begins, executable instructions may be loaded to or otherwise accessed in computer readable memory and executed by one or more computer processors of the model training system 600.

At block 204, the model training system 600 may obtain a corpus of training data 114. In some embodiments, as described above, the training data 114 may include a set of training data input vectors and a corresponding set of reference data output vectors. For example, if the prediction model 110 is being trained as a classifier, the training data input vectors 102 may include data regarding items or events to be classified. The reference data output vectors 104 may include scores indicating the proper classification(s) for the corresponding training data input vector 102 (e.g., scores of 1.0 for the proper classification(s), and scores of 0.0 for improper classification(s)). As another example, if the prediction model 110 is being trained as a regressor, the training data input vectors 102 may include data regarding items or events from which regression output is to be generated. Reference data output vectors 104 may include scores indicating the proper regression output(s) for the corresponding training data input vectors 102.

In some embodiments, the model training system 600 may separate the training data 114 into two or more subsets. For example, one subset may be used to train the model 110, and another subset may be used to test the trained model 110 and determine whether it has been adequately trained. In some embodiments, the model training system 600 may separate the training data 114 into k segments, or “folds” (where k is an integer greater than two) and use a cross-validation procedure such as k-fold cross-validation to train and test the model 110.

At block 206, the model training system 600 may determine the structure of the model 110 to be trained. The specific attributes of model structure available to be determined may depend on the type of model being trained. For example, if the model 110 is an artificial neural network, the model training system 600 may determine the quantity of internal layers, the quantity of nodes per layer, or the connectedness of the layers (e.g., fully connected layers vs. partially-connected layers). The particular attributes may be specified in a request or command sent to the model training system 600 to train the model, or they may be determined based on configuration data or programmatic instructions used by the model training system 600.

In some embodiments, block 206 may be executed (or re-executed) after at least a portion of training has occurred, and the structure of the model 110 may be modified through the addition of nodes, layers, etc., depending upon the feature space analysis performed by the model training system 600 during training. As one extreme example, the model 110 may initially be structured as a neural network with a single layer having a single node. The structure may be modified through addition of nodes, layers, etc. during the course of training to arrive at an optimal structure (from a size standpoint) for the training data being used and target use case of the model, as described below.

At block 208, the model training system 600 may initialize model parameters for the training process. The specific parameters and manner of initialization may depend on the type of model being trained. For example, if the model 110 is an artificial neural network, the model training system 600 may initialize the weights that correspond to connections between nodes in different layers. In some embodiments, the value of the weights may be randomly or pseudo-randomly determined, such as by using a pseudo-random number generator (PRNG) to determine substantially random values within the range of values that each weight is permitted to take (e.g., between 0.0 and 1.0).

At block 210, the model training system 600 may execute a training epoch. For example, the model training system 600 may process all training data input vectors 102 in the training set and generate training data output vectors 106. During the course of generating the training data output vectors 106, the model 110 may generate feature space data, such as feature vectors 154 representing the training data input vectors 102 in the feature space being learned as part of the training process.

The model training system 600 may evaluate the loss function for the current epoch. The loss function can evaluate the degree to which training data outputs (e.g., training data output vectors 106 generated using the model 110) differ from the desired or expected output (e.g., represented by reference data output vectors 104) for corresponding training data inputs (e.g., training data input vectors 102). Based on evaluation using the loss function, the model training system 600 can update some or all parameters of the model 110 so that when the same training data inputs are processed again (e.g., during subsequent epochs), the output produced by the model 110 will be closer to the desired output.

In some embodiments, the model training system 600 may compute a gradient based on differences between the training data output vectors 106 and the reference data output vectors 104. For example, gradient (e.g., a derivative) of the loss function can be computed. The gradient can be used to determine the direction in which individual parameters of the model 110 are to be adjusted in order to improve the model output (e.g., to produce output that is closer to the correct or desired output for a given input). The degree to which individual parameters are adjusted may be predetermined or dynamically determined (e.g., based on the gradient and/or a hyperparameter). Illustratively, the parameters may be adjusted using a gradient descent method with back propagation, as described in greater detail above.

In some embodiments, the model training system 600 may evaluate the loss function and update model parameters without necessarily processing the entire training set. Rather, the model training system 600 may do so after processing only a subset or “batch” of training data. For example, a training hyperparameter for batch size is set to a value that is less than the size of the training set. The gradient that is calculated for such a batch may be referred to as a “partial gradient” because it is not based on the entire corpus of training data. For each batch, the model training system 600 may evaluate the loss function for the current batch of training, update model parameters, and proceed with the next batch, if any remain in the training set.

At decision block 212, the model training system 600 can determine whether a convergence criterion has been satisfied. The convergence criterion may relate to the degree of accuracy of the model 110 after the most recent iteration of training (e.g., after the most recent epoch). For example, the degree of accuracy may be determined using the loss function, the test set, or both, and the convergence criterion may be a minimum or threshold degree of accuracy. The determination of whether the convergence criterion has been satisfied may be used in a subsequent block of the routine 200 to determine whether to adjust training, adjust the model structure, end training, or perform some other operation.

At block 214, the model training system 600 can evaluate the current feature space within which the model 110 is making predictions or otherwise generating training data output. To evaluate the current feature space, the model training system 600 can access and analyze feature space data generated from training data inputs. In some embodiments, the model training system 600 can analyze feature space points represented by feature vectors 154 that were generated from training data input vectors 102 during the current or most-recent training epoch. For example, the model training system 600 can determine which feature space points are associated with which class of the set of classes into which the model 110 is being trained to classify inputs, and therefore which regions of the feature space are associated with which class. As another example, the model training system 600 can execute a clustering process to identify clusters of feature space points within the feature space. The particular attributes of feature space points in the clusters (e.g., class or regression output represented by corresponding reference data output vectors, false positive or false negative predictions from feature space points in the clusters, etc.) can be used to identify and mitigate potential training-based issues, as described in greater detail below.

At decision block 216, the model training system 600 can determine whether a separability criterion has been satisfied. In some embodiments, poor separability of feature space points associated with two or more classes or groups of regression output can be identified. To identify poor separability, one or more distance metrics may be generated regarding a spatial distance between clusters of feature space points or regions of feature space associated with different outputs. For example, a Bhattacharyya distance, a Mahalanobis distance, or a Wasserstein metric may be generated to represent the distance between [1] a centroid, average, or other representative point associated with a first class, and [2] a centroid, average, or other representative point associated with a second class. If the distance metric fails to meet or exceed a threshold value, then a detection of poor separability may be triggered.

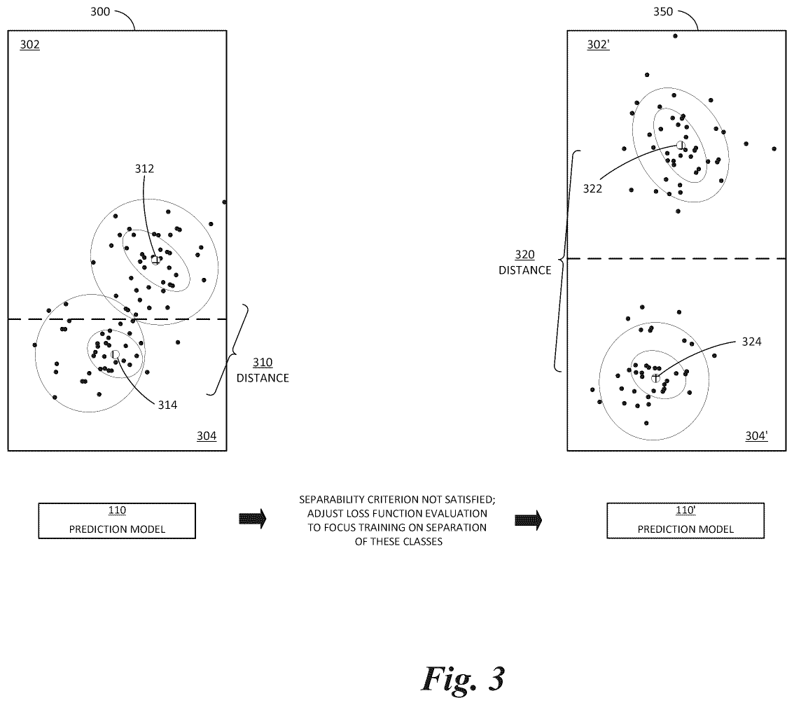

FIG. 3 illustrates an example of a set 300 of feature space points generated from training data input at training time. Generally, the prediction model 110 may classify a given training data input into a class if a feature space point is located within the boundaries of the class. In the illustration, a class boundary between class 302 and 304 is indicated using a dashed line. The feature space points are clustered in the two different classes. However, the clusters of feature space points are close to each other, in some cases overlapping. This can be indicative of poor separability. Moreover, due to the proximity of the clusters within the feature space, some points that are associated with a cluster that is within the region of the feature space associated with class 304 are located across the class boundary in the region associated with class 302, and vice versa.

To determine that the current feature space exhibits poor separability, the model training system 600 may determine whether a distance between features space points of different classes or regression outputs within the feature space fails satisfy a threshold distance. In the example illustrated in FIG. 3, the model training system 600 may determine a distance 310 between [1] a centroid, average, or other representation of feature space points classified in class 302, such as centroid 312, and [2] a centroid, average, or other representation of feature space points classified in class 304, such as centroid 314. If the distance 310 fails to satisfy a minimum threshold, then the separability criterion may not be satisfied. Otherwise, if the distance between such groupings of feature space points being evaluated satisfies the minimum distance threshold, then the separability criterion may be satisfied.

At decision block 218, the model training system 600 can determine whether a region of the feature space is associated with poor performance. For example, a classification model may be trained to classify inputs to difference classes. If the performance is measured only in terms of the total classification accuracy and ability to cluster across the entire training set and set of classes, the performance of the model be considered adequate even if clusters of errors exist. To uncover (comparatively small) clusters of errors, the feature space points generated from training data input vectors may be evaluated.

If the prediction model 110 is being trained is a classifier, poor performance may be indicated by occurrence of false positive or false negative classification determinations for feature space points generated from training data input vectors. If the prediction model 110 is being trained is a regressor, poor performance may be indicated by large negative or large positive errors determined for feature space points generated from training data input vectors. If a particular region of the feature space has a larger than expected or larger than threshold occurrence of such indicators of poor performance, detection of a region of poor performance may be triggered.

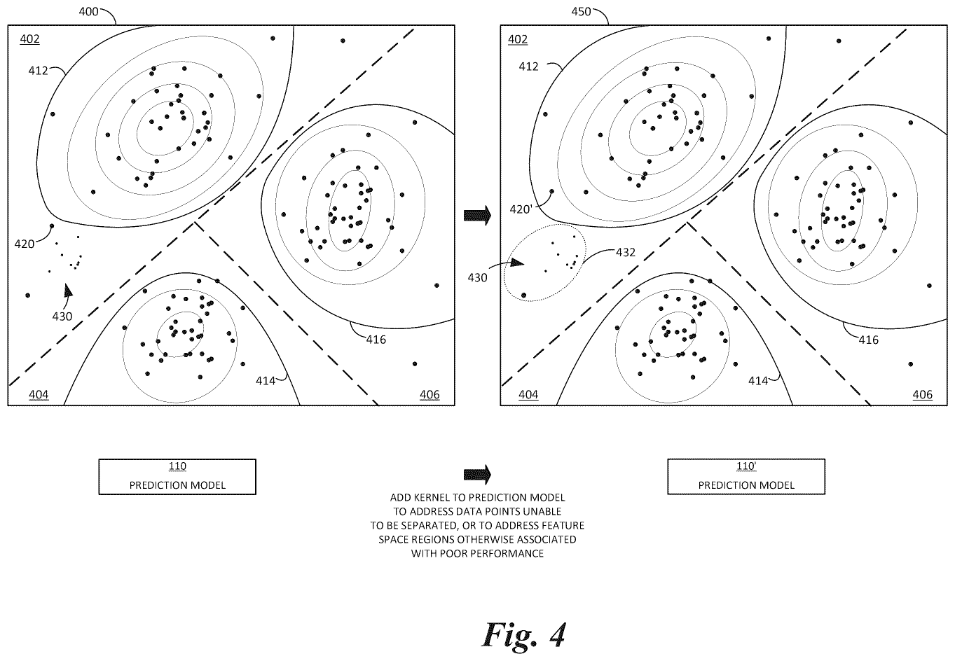

FIG. 4 illustrates, on the left side of the figure, a set 400 of feature space points generated from training data during a training routine. The feature space points are clustered in three different classes into which the prediction model 110 is being trained to classify inputs. Generally, the prediction model 110 may classify a given training data input into a class if a feature space point is located within the boundaries of the class. In the illustration, the class boundaries are indicated in dashed lines. Three classes are shown: class 402, class 404, and class 406.

As discussed above, the classification determinations may not necessarily be supported by the training data used to train the prediction model 110 thus far. The confidence model 112 may be used to evaluate the training data support for the classification determinations. In the illustration, the generally elliptical lines correspond to different degrees of confidence. The concentric nature of the generally elliptical lines may be interpreted as topographical indicators in a third dimension overlayed on top of a two-dimensional set 400 of feature space points. Generally, higher degrees of confidence are represented by smaller ellipses with fewer internal ellipses, and thus higher values in the third dimension. Lower degrees of confidence are represented by larger ellipses with more internal ellipses, and thus lower values in the third dimension. The region within generally elliptical line 412 indicates a relatively low degree of confidence for class 402 such that feature space points outside of the region, including feature space point 420, may be classified in class 402 with a low degree of confidence (or may not be classified in class 402 at all). The region within generally elliptical line 414 is a relatively low degree of confidence for class 404, and the region within generally elliptical line 416 is a relatively low degree of confidence for highest degree of confidence for class 406.

The example in FIG. 4 of a two-dimensional feature space with confidence indicated in a third dimension is for illustrative purposes only, and is not intended to be limiting or required. A topographical map with a height corresponding to degree of confidence in points and regions of a two-dimensional feature space is merely one method of visualizing confidence in feature space points and regions. Moreover, it will be appreciated that in some embodiments a feature space may be defined in three or more dimensions, and potentially a large number of dimensions (e.g., dozens, hundreds, or more).

In the example shown in FIG. 4, a cluster 430 of feature space points is located outside of generally elliptical line 412, but within the boundary of class 402. Because they are within the boundary of class 402 but outside of generally elliptical line 412, the feature space points in the cluster 430 may be classified in class 402 with low confidence. However, only some of the feature space points in the cluster 430 may be properly classified in class 402, while other points may be properly classified in other classes. That, in addition to the relatively large size of the cluster, can result in the region in which the cluster is found being identified as a region of poor performance.

To detect a region of poor performance, the model training system 600 may identify a region satisfying one or more criteria, such as a cluster of feature space points in a region of low confidence, or a cluster of feature space points with quantity or proportion of inaccuracies (e.g., false positives, false negatives, large positive errors, large negative errors, etc.). For example, the criteria may include a threshold distance (e.g., based on a distance metric such as a Bhattacharyya distance, a Mahalanobis distance, or a Wasserstein metric) between [1] a centroid, average, or other representation of the potential region of poor performance, and [2] a centroid, average, or other representation of existing classes within which the prediction model 110 is being trained to classify data. If the distance between the identified region and the centroid of existing classes exceeds a threshold, then the region may be identified as a region of poor performance. Another example criterion may be a clustering criterion, such as a threshold quantity of incorrectly-classified feature space points being observed within a threshold distance of each other. Another example criterion may be a confidence-based criterion, such as a threshold quantity of incorrectly-classified or low-confidence classified feature space points being observed within a threshold distance of each other. If a set of feature space points, such as cluster 430, satisfies one or more such criteria, then the region in which the feature space points are located may be considered a region of poor performance.

Returning to FIG. 2, at block 220 the model training system 600 may determine an operation to be performed based on the status and context of the training thus far. The model training system 600 may consider whether a convergence criterion is satisfied (e.g., as determined at decision block 212), whether a separability criterion has been satisfied (e.g., as determined at decision block 216), whether a region of poor performance has been detected (e.g., as determined at decision block 218), other information, or some combination thereof.

In some embodiments, if neither the convergence criterion nor the separability criterion have been satisfied, the model training system 600 may determine to continue training. For example, the model training system 600 may determine to execute another training epoch, and the routine 200 may return to block 210.

In some embodiments, if the convergence criterion has not been satisfied while the separability criterion has been satisfied, the model training system 600 may determine to add training data, re-initialize model parameters, or continue training with the current training data without re-initializing model parameters. For example, the feature space learned thus far in training may provide adequate separability, but adding training data (e.g., using a supplemental corpus of training data) may help to reach convergence and satisfy the convergence criterion after one or more additional training epochs. The routine 200 may therefore return to block 204 (optionally skipping blocks 206 and 208).

As another example, the feature space learned thus far in training may provide adequate separability, but the current state of the parameters may be inhibiting progress (e.g., some parameters may be caught in a local minimum or maximum). Re-initializing some or all parameters may allow further training epochs to result in convergence of the model 110. The routine 200 may therefore return to block 208.

As a further example, the feature space learned thus far in training may provide adequate separability, but executing one or more additional training epochs may help to reach convergence and satisfy the convergence criterion. The routine 200 may therefore return to block 210.

In some embodiments, if the convergence criterion has been satisfied while the separability criterion has not been satisfied, the model training system 600 may determine to adjust the structure of the model, re-initialize model parameters, or adjust the manner in which the loss function is used. For example, the feature space learned thus far in training may provide performance that is adequate to satisfy the convergence criterion (e.g., the error at training time falls below a threshold), but the current state of the parameters may be inhibiting progress (e.g., some parameters may be caught in a local minimum or maximum). Re-initializing some or all parameters may allow further training epochs to result in achieving adequate separability within the feature space of the model 110. The routine 200 may therefore return to block 208.

As another example, the feature space learned thus far in training may provide performance that is adequate to satisfy the convergence criterion (e.g., the error at training time falls below a threshold), but adjusting the manner in which the loss function is evaluated and used to update parameter values may be adjusted. Adjustment in use of the loss function may include adjusting output of the loss function (e.g., by reducing the value, increasing the value, or applying a weighting factor to the value) for regions of the feature space that exhibit poor separability. This can cause additional effort to be focused on improving separability in the feature space during subsequent training batches or epochs.

As a further example, the feature space learned thus far in training may provide performance that is adequate to satisfy the convergence criterion (e.g., the error at training time falls below a threshold), but adjusting the model structure may allow the feature space to also provide a desired degree of separability.

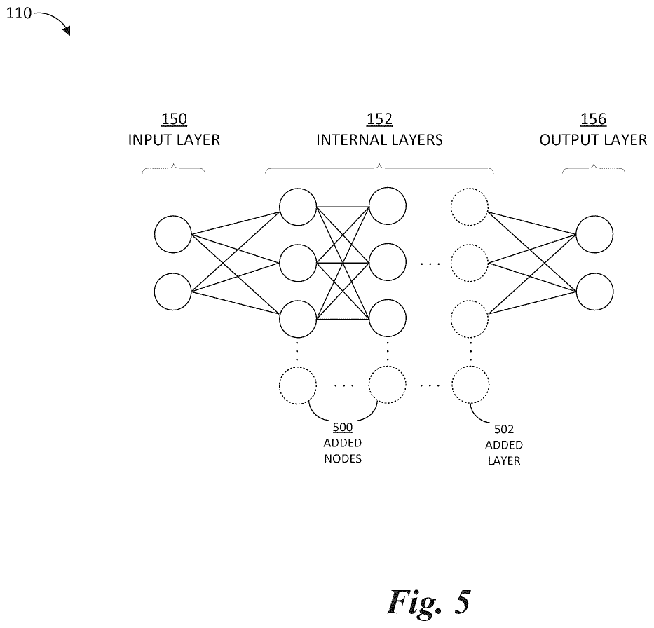

FIG. 5 illustrates example structural modifications to a prediction model 110. As shown, the model 110 is implemented as an artificial neural network with an input layer 150, a set of internal layers 152, and an output layer 156. Each layer includes its own set of nodes, and nodes of adjacent layers may be connected such that the value of a node in one layer depends on the values of one or more nodes of a prior layer. The model training system 600 may adjust the structure of such a model in various ways. For example, the model training system 600 may add additional nodes 500 to one or more layers of the model, or add additional layers 502 to the model, thereby producing a deeper neural network structure. By producing a deeper structure, the model training system 600 increases the quantity of parameters in the model, which can increase the opportunities for learning features that may improve separability.

In some embodiments, the model training system may perform other modifications to the prediction model 110 instead of, or in addition to, addition of layers and/or nodes. For example, the model training system may remove one or more nodes and/or one or more layers of the model, thereby producing a more compact neural network structure. As another example, the model training system may modify the type of one or more nodes (e.g., by altering the activation function) and/or alter weights and/or biases associated with individual nodes. As a further example, the model training system may alter one or more training hyperparameters.

The example modifications described herein that the model training system may make to the prediction model 110 or training thereof are illustrative only, and are not intended to be limiting, required, or exhaustive. In some embodiments, additional or alternative modifications may be made.

Returning to FIG. 3, set 350 of feature space points shows an example of the effect of implementing an adjustment to training based on feature space analysis, such as re-initializing model parameters, adjusting the manner in which the loss function is used to improve separability, or adjusting the structure of the model 110 to produce model 110′. As shown, the distance 320 between centroid 322 (for modified class 302′) and centroid 324 (for modified class 304′) is significantly greater after implementation of an adjustment to training than the distance 310 between centroids 312 and 314 before implementation of the adjustment. In this example, the magnitude of distance 320 may be greater than a predetermined or dynamically-determined threshold, and accordingly the separability criterion may now be satisfied.

In some embodiments, if both the convergence criterion and separability criterion are satisfied but a region of poor performance is nevertheless detected, the model training system 600 may determine to adjust the structure of the model, or adjust the manner in which the loss function is used. For example, the model training system 600 may adjust the manner in which the loss function is evaluated and used to update parameter values. Adjustment in use of the loss function may include adjusting output of the loss function for regions of the feature space that exhibit poor performance. This can cause additional effort to be focused on improving performance in the feature space during subsequent training batches or epochs.

FIG. 4 shows set 450 of feature space points, including classification of point 420′—generated from the same training data input as point 420 in set 400—after adjustment of the loss function, execution of one or more additional training epochs, and training updated model 110′. As shown, model 110′ has learned to generate feature space point 420′ in a region of the feature space that is associated with a higher degree of confidence for class 402 than was the case before the adjustment to training.

As another example, adjusting the model structure such as by adding a kernel may improve performance in the region of the feature space associated with poor performance. A kernel may be added to treat the region of the feature space associated with poor performance separately from the rest of the feature space. Such a kernel may be generated to provide one or more regions of relatively high degree(s) of confidence, where the regions would otherwise be outside of the high confidence regions of the feature space as modeled by the confidence model 112. Illustratively, a kernel 432 may be implemented to define the cluster of feature space points 430 shown in FIG. 4. For example, a Gaussian kernel may be implemented to determine the distance of data points from the center of a particular cluster, such as cluster of feature space data points 430 associated with class 402 that are also located outside of generally elliptical line 412. The center of the particular cluster of feature space data points 430 may be indicated by the mean of the Gaussian that models the cluster. The difference between a point and the mean may be divided by the standard deviation of the Gaussian that models the cluster. Depending upon which direction the point is offset from the mean in the feature space, the distance may be adjusted based on the standard deviation of the Gaussian in that direction. In this way, a feature space point with a distance value (or adjusted distance value) that is within a particular threshold value for the kernel 432 or otherwise within a particular feature space region may be considered to be properly classified in a particular class (e.g., class 402 with a higher degree of confidence, or in a class other than class 402).

Returning to FIG. 2, if all applicable convergence and separability criteria have been satisfied, and there are no regions of poor performance remaining, the routine 200 may terminate at block 222. In some embodiments, the routine 200 may terminate at block 222 in response to other events. For example, after performance of a predetermined quantity of training epochs, after passage of a predetermined period of time, or the like. In this way, the training routine 200 may not proceed indefinitely if all applicable criteria are not satisfied.

### Dynamically Optimized Neural Network Structure

In some embodiments, the model structure adjustment operations, parameter re-initialization operations, and other feature space analysis-based training adjustments described herein may be used to dynamically generate an optimized neural network structure from a given corpus of training data. The structure may be optimized in the sense that it includes the minimum quantity of layers, nodes, or computations to produce output satisfying various criteria, such as a convergence criterion and separability criterion.

Table 1 below illustrates an example algorithm that may be used to start with a minimal model structure (e.g., one internal layer with a single node), and re-initialize model parameters or modify the structure of the model (or both) until a separability criterion is satisfied.

TABLE 1

```
1. Start with a one-neuron network
2. Train until bias and gain converge
3. Test with separability criterion
  A. Separability criterion passes threshold?
    i. If yes, training is complete
    ii. If no:
      a. Reinitialize parameters and return to (2.)
        *or*
      b. Add node(s) or layer(s) and return to (2.)
```

### Execution Environment

FIG. 6 illustrates various components of an example model training system 600 configured to implement various functionality described herein. The model training system 600 may be or include one or more physical host computing devices.

In some embodiments, as shown, a model training system 600 may include: one or more computer processors 602, such as physical central processing units (“CPUs”); one or more network interfaces 604, such as a network interface cards (“NICs”); one or more computer readable medium drives 606, such as a high density disk (“HDDs”), solid state drives (“SSDs”), flash drives, and/or other persistent non-transitory computer readable media; and one or more computer readable memories 610, such as random access memory (“RAM”) and/or other volatile non-transitory computer readable media.

The computer readable memory 610 may include computer program instructions that one or more computer processors 602 execute and/or data that the one or more computer processors 602 use in order to implement one or more embodiments. For example, the computer readable memory 610 can store an operating system 612 to provide general administration of the model training system 600. As another example, the computer readable memory 610 can store confidence model training instructions 614 for implementing feature space analysis-based training adjustments. As another example, the computer readable memory 610 can store confidence model adjustment instructions 616 for adjusting a structure of a prediction model.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
computer-readable memory storing executable instructions; and
one or more processors programmed by the executable instructions to at least:
obtain a corpus of training data comprising a plurality of training data input vectors and a plurality of reference data output vectors, wherein a reference data output vector of the plurality of reference data output vectors represents a desired output generated by an artificial neural network from a corresponding training data input vector of the plurality of training data input vectors;
execute a first training epoch to train the artificial neural network using the corpus of training data, wherein to train the artificial neural network, the one or more processors are programed to:
evaluate a first training data input item using the artificial neural network to determine a first feature space point in a feature space; and
generate first training output data based on the first feature space point, wherein the first training output data represents a first class of a plurality of classes;
evaluate feature space data regarding a plurality of feature space points generated from evaluating at least a subset of the plurality of training data input vectors;
determine, based on results of evaluating the feature space data, that a separability criterion is not satisfied;
modify a structure of the artificial neural network; and
execute a second training epoch of the artificial neural network.

2. The system of claim 1, wherein to modify the structure of the artificial neural network, the one or more processors are further programmed by the executable instructions to add a layer to the artificial neural network or add a node to the layer of the artificial neural network.

3. The system of claim 1, wherein to evaluate the feature space data, the one or more processors are programmed by the executable instructions to:
identify a first feature space point cluster comprising a subset of the plurality of feature space points, wherein the first feature space point cluster is associated with the first class; and
determine that the first feature space point cluster is less than a threshold distance from a second feature space point cluster associated with a second class of the plurality of classes.

4. The system of claim 3, wherein the one or more processors are further programmed by the executable instructions to determine a distance of the first feature space point cluster from the second feature space point cluster, wherein the distance comprises one of: a Bhattacharyya distance, a Mahalanobis distance, or a Wasserstein metric.

5. The system of claim 1, wherein the one or more processors are further programmed by the executable instructions to determine, based on results of evaluating the feature space data, that a convergence criterion is satisfied.

6. The system of claim 1, wherein the one or more processors are further programmed by the executable instructions to determine, based on results of evaluating the feature space data, that a convergence criterion is not satisfied.

7. A computer-implemented method comprising:
under control of a computing system comprising one or more processors configured to execute specific instructions,
initiating training of an artificial neural network using a corpus of training data comprising a plurality of training data input items and a plurality of reference data output items, wherein training the artificial neural network comprises:
evaluating a first training data input item using the artificial neural network to determine a first feature space point in a feature space; and
generating first training output data based on the first feature space point, wherein the first training output data represents a first class of a plurality of classes;
evaluating feature space data regarding a plurality of feature space points generated from evaluating at least a subset of the plurality of training data input items;
determining, based on results of evaluating the feature space data, that a separability criterion is not satisfied; and
modifying training of the artificial neural network based on the separability criterion not being satisfied.

8. The computer-implemented method of claim 7, further comprising determining that a convergence criterion is not satisfied, wherein modifying the training of the artificial neural network is further based on the convergence criterion not being satisfied.

9. The computer-implemented method of claim 7, further comprising determining that a convergence criterion is satisfied, wherein modifying the training of the artificial neural network is further based on the convergence criterion being satisfied.

10. The computer-implemented method of claim 7, wherein evaluating the feature space data comprises:
identifying a first feature space point cluster comprising a subset of the plurality of feature space points, wherein the first feature space point cluster is associated with a first class of the plurality of classes; and
determining that the first feature space point cluster is less than a threshold distance from a second feature space point cluster associated with a second class of the plurality of classes.

11. The computer-implemented method of claim 10, further comprising determining a distance of the first feature space point cluster from the second feature space point cluster, wherein the distance comprises one of: a Bhattacharyya distance, a Mahalanobis distance, or a Wasserstein metric.

12. The computer-implemented method of claim 7, wherein modifying the training of the artificial neural network comprises:
obtaining a supplemental corpus of training data; and
executing a training epoch using the supplemental corpus of training data.

13. The computer-implemented method of claim 7, wherein modifying the training of the artificial neural network comprises reinitializing at least a subset of parameters of the artificial neural network.

14. The computer-implemented method of claim 7, wherein modifying the training of the artificial neural network comprises modifying a loss function, used to update parameters of the artificial neural network, to adjust loss function output associated with a subset of the plurality of feature space points.

15. The computer-implemented method of claim 7, wherein modifying the training of the artificial neural network comprises at least one of:
adding a layer to an artificial neural network;
removing the layer from the artificial neural network;
adding a node to an existing layer of the artificial neural network;
removing a node from the existing layer of the artificial neural network;
changing a type of a node; or
adjusting a hyperparameter.

16. The computer-implemented method of claim 7, wherein modifying the training of the artificial neural network comprises generating a kernel for the artificial neural network, wherein the kernel is configured to evaluate a subset of the plurality of feature space points.

17. A system comprising:
computer-readable memory storing a corpus of training data comprising a plurality of training data input items and a plurality of reference data output items; and
one or more processors programmed by executable instructions to at least:
initiate training of a machine learning model using the corpus of training data, wherein to train the machine learning model, the one or more processors are further programmed by the executable instructions to:
evaluate a first training data input item using the machine learning model to determine a first feature space point in a feature space; and
generate first training output data based on the first feature space point;
evaluate feature space data regarding a plurality of feature space points generated from evaluating at least a subset of the plurality of training data input items;
determine, based on results of evaluating the feature space data, that a separability criterion is not satisfied; and
modify training of the machine learning model based on the separability criterion not being satisfied.

18. The system of claim 17, wherein to evaluate the feature space data, the one or more processors are further programmed by the executable instructions to:
identify a first feature space point cluster comprising a subset of the plurality of feature space points, wherein the first feature space point cluster is associated with a first class of a plurality of classes;
determine that the first feature space point cluster is less than a threshold distance from a second feature space point cluster associated with a second class of the plurality of classes; and
determine a distance of the first feature space point cluster from the second feature space point cluster, wherein the distance comprises one of: a Bhattacharyya distance, a Mahalanobis distance, or a Wasserstein metric.

19. The system of claim 17, wherein to modify training of the machine learning model, the one or more processors are further programmed by the executable instructions to modify a loss function, used to update parameters of the machine learning model, to adjust loss function output associated with a subset of the plurality of feature space points.

20. The system of claim 17, wherein to modify training of the machine learning model, the one or more processors are further programmed by the executable instructions to add a layer to the machine learning model, wherein the machine learning model is an artificial neural network.
